(19) United States
(12) Patent Application Publication
(10) Pub. No.: US 2006/0256558 A1
(43) Pub. Date: Nov. 16, 2006

(54) Firecracker-like light string

(76) Inventor: Hung-Wen Lee, Chupei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/125,091

(22) Filed: May 10, 2005

(51) Int. Cl. F21S 13/14

(52) U.S. Cl. 362/252

(57) ABSTRACT

The invention relates to a firecracker-like light string, which includes bulb assemblies on both sides as a string of firecrackers. Blind wires are interconnected with the electrical wire to position the bulb assemblies on both sides of the electrical wires in secure. The string can be hung without other supporting frame to display a spiral firecracker-like decorative effect.

### FIELD OF THE INVENTION

The present invention relates to a light string, which has an outlook as a string of firecrackers.

### BACKGROUND OF THE INVENTION

A conventional light string is usually applied for decoration. Since the light string is made of soft material, it is difficult to pattern the light string to have a stable configuration. The known light string is always hung randomly or is supported by another patterned frame to display a certain outlook for decoration. That is the known light string cannot provide a decorative structure firmly by itself.

### SUMMARY OF THE INVENTION

The present invention is to provide a light string having a firecracker-like outlook, which is completed by wires without any further patterned frame. It can be used or hung independently to obtain a better decorative effect. Now, accompanying with the following drawings, the character of the present invention will be described here and after.

### BRIEF DESCRIPTION OF THE DRAWINGS

FIG. 1 is a perspective view showing a firecracker-like light string according to the present invention.

FIG. 2 is an illustrated plan view showing the connecting structure between wires of the light string according to the present invention.

FIG. 3 is plan view showing another embodiment of the light string having a controller.

### DETAILED DESCRIPTION OF TIHE PREFERRED EMBODIMENT

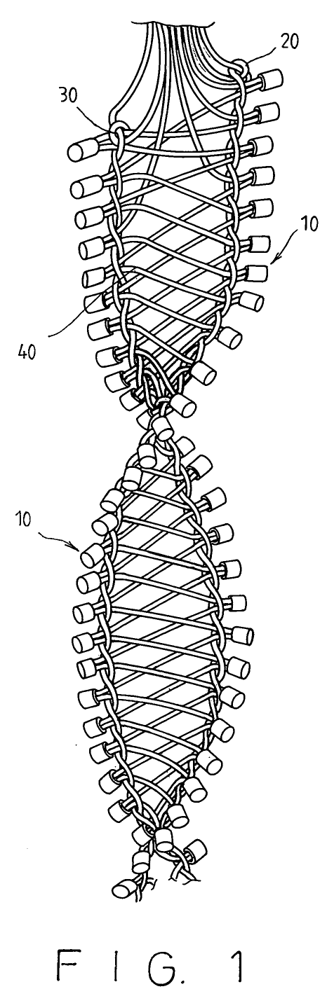

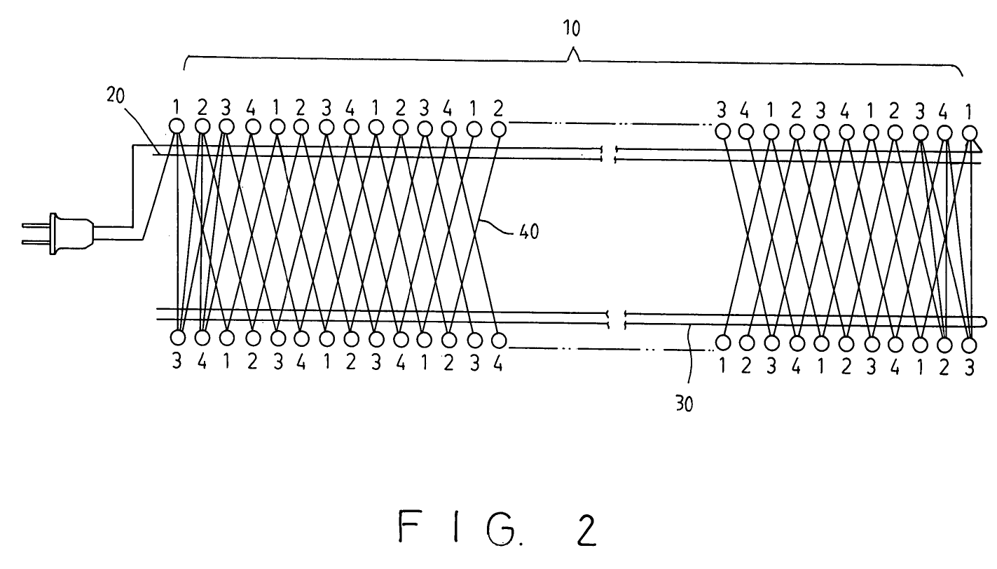

Please refer to FIG. 1, the present invention relates to a light string having an outlook similar to a string of firecrackers, wherein the bulb assemblies (10) are placed on two sides of the string, which is therefore spiral with special decorative effect due to the gravity. The connecting structure of the light string is shown in FIG. 2, the bulb assemblies (10) are placed on two sides while a pair of blind wires (20) and (30) are interconnected with electrical wires (4) of the light string at inner portion relating to the bulb assemblies (10). Hence, every bulb assemblies (10) are positioned on both sides of the light string, which has an outlook as a string of firecrackers.

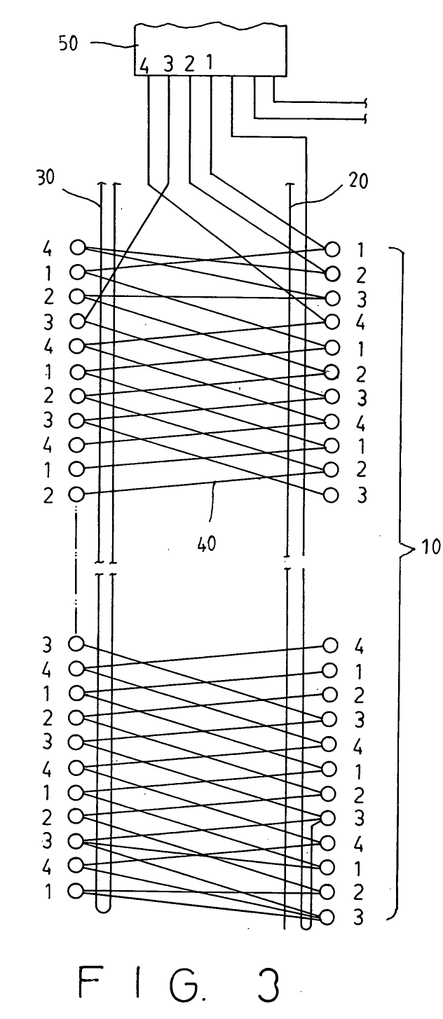

FIG. 3 shows another embodiment of this application. A controller (50) is provided to connect with the electrical wires (40) of the light string that obtains a different lighting effect.

Accordingly, the present invention uses the blind wires to connect with the electrical wires for placing the bulb assemblies on both sides of the light string. It can display a certain decorative outlook, such as a string of firecrackers without any extra supporting frame. It can be understood that the present invention includes improvement and utilization with no doubt and is obviously allowable.

I claim:

1. A firecracker-like light string including an electrical wires connecting with many bulb assemblies on both sides, wherein blind wires are interconnected with the electrical wire at inner portion of the bulb assemblies to position them on both sides of the electrical wires in secure.

2. The firecracker-like light string as claimed in claim 1, wherein a controller is provided to connect with the electrical wires for controlling the bulbs lighting.
